(19) United States
(12) Patent Application Publication
(10) Pub. No.: US 2024/0399861 A1
(43) Pub. Date: Dec. 5, 2024

(54) DYNAMIC AUDIO CHANNEL CONFIGURATION FOR A VEHICLE

(71) Applicant: QUALCOMM Incorporated, San Diego, CA (US)

(72) Inventors: Pruthvi Raj SINGH, Hyderabad (IN); Vishnu Vardhan KASILYA SUDARSAN, Bangalore (IN); Nikhil VERMA, Bangalore (IN); Chaithanya Krishna BACHARAJU, Hyderabad (IN)

(21) Appl. No.: 18/327,352

(22) Filed: Jun. 1, 2023

(51) Int. Cl. B60K 35/00; H04R 3/12

(52) U.S. Cl. CPC B60K 35/00; H04R 3/12; B60K 35/20; B60K 35/22; B60K 35/26; B60K 35/65; B60K 2360/151; B60K 2360/741; H04R 2499/13

(57) ABSTRACT

In some aspects, a device may obtain information indicating a seating configuration for a vehicle, and determine, in accordance with the seating configuration, that there is a change to an orientation of a seat from a front-facing orientation to a rear-facing orientation or from the rear-facing orientation to the front-facing orientation. The device may cause, in accordance with the change to the orientation of the seat, an adjustment of a mapping of audio channels to speakers of the vehicle. The device may determine, in accordance with the seating configuration, that the adjustment of the mapping is to cause disagreement between visual content on a display device associated with an additional seat and multiple-channel audio to be output by the speakers, and cause an adjustment of the visual content on the display device to cause agreement between the visual content and the multiple-channel audio. Numerous other aspects are described.

### FIELD OF THE DISCLOSURE

Aspects of the present disclosure generally relate to multiple-channel audio and, for example, to dynamic audio channel configuration for a vehicle.

### BACKGROUND

In autonomous driving, a computing system may operate control elements of a motor vehicle without the assistance from a human operator of the vehicle. For example, sensors (e.g., camera sensors, radar sensors, and/or lidar sensors) may be installed on a motor vehicle to detect the conditions of the surroundings of the vehicle traveling on a roadway. A computing system installed on the vehicle analyzes inputs received from the sensors to identify the conditions and generate control signals or commands for the autonomous adjustments of the direction and/or speed of the vehicle, with or without any input from a human operator of the vehicle. Because autonomous operation of a vehicle may need minimal or no human involvement, some autonomous vehicles may be equipped with seats that can be rotated based on occupant preferences. For example, a seat may be rotated from a front-facing orientation to a rear-facing orientation.

### SUMMARY

Some aspects described herein relate to a method. The method may include obtaining, by a device, information indicating a seating configuration for one or more seats of a vehicle. The method may include determining, by the device and in accordance with the seating configuration, that there is a change to an orientation of a seat, of the one or more seats, from a front-facing orientation to a rear-facing orientation or from the rear-facing orientation to the front-facing orientation. The method may include causing, by the device and in accordance with the change to the orientation of the seat, an adjustment of a mapping of audio channels to speakers of the vehicle. The method may include determining, by the device and in accordance with the seating configuration, that the adjustment of the mapping is to cause disagreement between visual content on a display device associated with an additional seat, of the one or more seats, and multiple-channel audio, associated with the visual content, to be output by the speakers. The method may include causing, by the device, an adjustment of the visual content on the display device to cause agreement between the visual content and the multiple-channel audio.

Some aspects described herein relate to a controller. The controller may include one or more memories and one or more processors coupled to the one or more memories. The one or more processors may be configured to obtain information indicating a seating configuration for one or more seats of a vehicle. The one or more processors may be configured to determine, in accordance with the seating configuration, that there is a change to a directional orientation of a seat of the one or more seats. The one or more processors may be configured to cause, in accordance with the change to the directional orientation of the seat, an adjustment of a mapping of audio channels to speakers of the vehicle.

Some aspects described herein relate to a controller. The controller may include one or more memories and one or more processors coupled to the one or more memories. The one or more processors may be configured to obtain information indicating a seating configuration for one or more seats of a vehicle. The one or more processors may be configured to determine, in accordance with the seating configuration, that there is a disagreement between visual content on a display device associated with a seat, of the one or more seats, and multiple-channel audio associated with the visual content. The one or more processors may be configured to cause an adjustment of the visual content on the display device to cause agreement between the visual content and the multiple-channel audio.

Some aspects described herein relate to an apparatus. The apparatus may include means for obtaining information indicating a seating configuration for one or more seats of a vehicle. The apparatus may include means for determining, in accordance with the seating configuration, that there is a change to a directional orientation of a seat of the one or more seats. The apparatus may include means for causing, in accordance with the change to the directional orientation of the seat, an adjustment of a mapping of audio channels to speakers of the vehicle.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example vehicle in which systems and/or methods described herein may be implemented.

FIG. 2 is a diagram illustrating example components of a device, in accordance with the present disclosure.

FIGS. 3A-3E are diagrams of an example associated with dynamic audio channel configuration.

FIG. 4 is a flowchart of an example process associated with dynamic audio channel configuration.

FIG. 5 is a flowchart of an example process associated with dynamic audio channel configuration for a vehicle.

FIG. 6 is a flowchart of an example process associated with dynamic audio channel configuration for a vehicle.

FIG. 7 is a flowchart of an example process associated with dynamic audio channel configuration for a vehicle.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

As described above, a vehicle, such as an autonomous vehicle, may be equipped with seats that can be rotated in various directional orientations. For example, a seat of the vehicle may be positioned in a front-facing orientation (in a forward travel direction of the vehicle), in a rear-facing orientation (opposite a forward travel direction of the vehicle), or in a side-facing orientation that is between the front-facing orientation and the rear-facing orientation. Moreover, the vehicle may be equipped with a set of speakers, for an audio system of the vehicle, that are in fixed locations throughout the vehicle (e.g., one or more speakers located at the left side of the vehicle, one or more speakers located at the right side of the vehicle, one or more speakers located at the center of the vehicle, or the like). The audio system may be capable of multiple-channel audio (e.g., surround sound audio, such as 5.1.2 surround sound, 7.1.4 surround sound, or 9.1.6 surround sound, which may include surround sound effects, such as audio panning), and the multiple-channel audio may be mapped to the set of speakers such that each speaker outputs a particular audio channel. For example, a left side audio channel may be mapped to one or more speakers located at the left side of the vehicle, and a right side audio channel may be mapped to one or more speakers located at the right side of the vehicle.

Accordingly, when an occupant of the vehicle changes a directional orientation of a seat (e.g., from a front-facing orientation to a rear-facing orientation), the audio output of the set of speakers may be reversed, or otherwise dissonant, from the occupant's perspective, thereby resulting in a poor user experience. For example, a right side audio channel may be output by speakers located to the occupant's left, and a left side audio channel may be output by speakers located to the occupant's right. The poor user experience may be exacerbated when the multiple-channel audio is associated with visual content that is on a display viewed by the occupant (e.g., the multiple-channel audio may be for a movie or a video game). For example, in a front-facing orientation, the occupant may be watching a scene in a movie in which an airplane flies from a left side of the screen to a right side of the screen, and surround sound effects for the scene may pan the audio from left side speakers to right side speakers matching the airplane's flight. However, if the occupant's seat is rear-facing, then the occupant may hear the audio for the scene panning from the occupant's right side to the occupant's left side. Furthermore, additional complexity in achieving an acceptable user experience may arise when there are multiple occupants in the vehicle, each in a respective seat orientation and each consuming content (e.g., the same content or different content) that uses the vehicle's audio system.

Some aspects described herein enable dynamic audio channel configuration in accordance with a seating configuration of a vehicle. For example, some aspects resolve or prevent loss of directional synchronization between multiple-channel audio output by speakers of the vehicle and visual content (e.g., video) on a display device of the vehicle, from the perspective of an occupant of the vehicle that is using (e.g., viewing) the display device. In some aspects, an adjustment to an output audio configuration of the vehicle may be made in accordance with a change to a directional orientation of a seat of the vehicle. For example, a mapping of audio channels to speakers may be adjusted in accordance with the change to the directional orientation of the seat. As an example, responsive to a change to the directional orientation of the seat from a front-facing orientation to a rear-facing orientation, a left-side audio channel may be mapped to a right-side speaker of the vehicle and a right-side audio channel may be mapped to a left-side speaker of the vehicle. Thus, the adjustment to the mapping may follow the change of the seat's directional orientation to maintain or restore agreement between an output of the audio system and an occupant's position and orientation in the vehicle.

Some aspects described herein resolve or prevent audio output conflicts that may occur when the vehicle has multiple occupants. For example, if one or more seats are in a front-facing orientation and one or more seats are in a rear-facing orientation, then disagreement may arise between visual content on a display device associated with a seat and multiple-channel audio, associated with the visual content, to be output by the speakers. In some aspects, responsive to the disagreement, the visual content on the display device may be adjusted, such as flipped (e.g., a horizontal, mirror-image flip), thereby synchronizing the visual content and the multiple-channel audio at the display device. Moreover, in some aspects, the non-textual content of the visual content may be adjusted (e.g., flipped) without adjusting (e.g., flipping) textual content of the visual content. In this way, all display devices of the vehicle may present the visual content in a manner that agrees with the multiple-channel audio, from the perspective of the occupants using the display devices, even if one or more seats of the vehicle have been rotated.

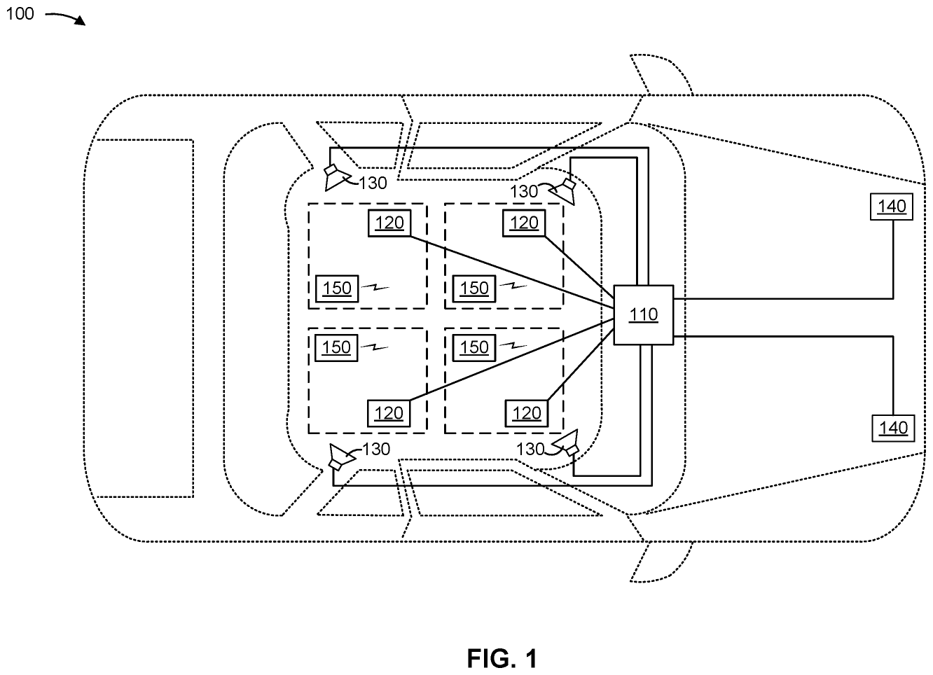

FIG. 1 is a diagram of an example vehicle 100 in which systems and/or methods described herein may be implemented. As shown in FIG. 1, vehicle 100 may include a controller 110, one or more seat sensing devices 120, one or more audio output devices 130, one or more environment sensing devices 140, and/or one or more display devices 150, among other examples. Devices of vehicle 100 may interconnect via wired connections, wireless connections, or a combination of wired and wireless connections.

The controller 110 may include one or more devices capable of receiving, generating, storing, processing, providing, and/or routing information associated with dynamic audio channel configuration, as described elsewhere herein. The controller 110 may include a communication device and/or a computing device. For example, the controller 110 may include an electronic control module, an electronic control unit, a central control module, a general electronic module, a microcontroller, or a device in a cloud computing system. In some aspects, the controller 110 may control an audio system of the vehicle 100 and/or an infotainment system of the vehicle 100.

A seat sensing device 120 may include one or more devices capable of receiving, generating, storing, processing, and/or providing information associated with characteristics or conditions at a seat of the vehicle 100, as described elsewhere herein. For example, the seat sensing device 120 may be capable of detecting a directional orientation of a seat and/or whether a seat is occupied by a person, among other examples. The seat sensing device 120 may include a communication device and/or a computing device. For example, the seat sensing device 120 may include a seat control unit, a sensor module, or one or more sensor devices. In some aspects, the seat sensing device 120 may include a rotation sensor and/or a pressure sensor.

An audio output device 130 may include one or more devices capable of receiving audio signals and outputting audio based on the audio signals. The audio output device 130 may include a speaker (e.g., a loudspeaker, a subwoofer, a soundbar, or the like).

An environment sensing device 140 may include one or more devices capable of receiving, generating, storing, processing, and/or providing information associated with characteristics or conditions of an environment of the vehicle 100. For example, the environment sensing device 140 may be capable of detecting objects in a vicinity of the vehicle 100, roadway boundaries, and/or traffic signals and signs, among other examples. The environment sensing device 140 may include a communication device and/or a computing device. For example, the environment sensing device 140 may include a radar unit, a lidar unit, or a camera module. In some aspects, the controller 110 may control autonomous operation of the vehicle 100 using measurements or other data collected by the environment sensing device 140.

A display device 150 may include one or more devices capable of receiving, generating, storing, processing, providing, and/or displaying information associated with visual content (e.g., video), information associated with the infotainment system of the vehicle 100, and/or information associated with the audio system of the vehicle 100. The display device 150 may include a communication device and/or a computing device. For example, the display device 150 may include a wireless communication device, a mobile phone, a user equipment, a laptop computer, a tablet computer, a wearable communication device (e.g., a head mounted display or a virtual reality headset), or a similar type of device.

The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of vehicle 100 may perform one or more functions described as being performed by another set of devices of vehicle 100.

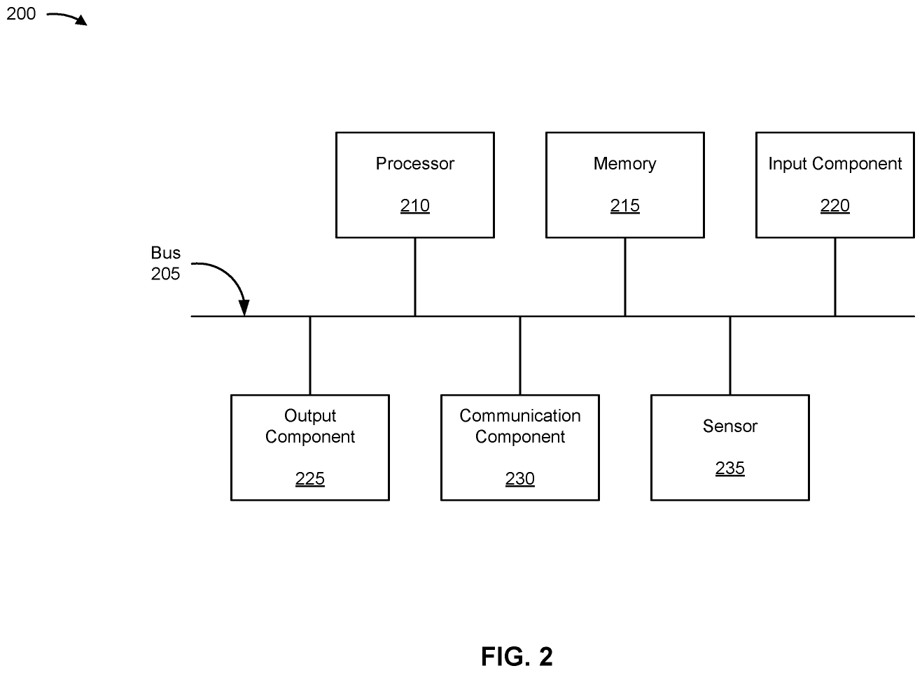

FIG. 2 is a diagram illustrating example components of a device 200, in accordance with the present disclosure. The device 200 may correspond to vehicle 100, controller 110, a seat sensing device 120, an audio output device 130, an environment sensing device 140, and/or a display device 150. In some aspects, vehicle 100, controller 110, a seat sensing device 120, an audio output device 130, an environment sensing device 140, and/or a display device 150 may include one or more devices 200 and/or one or more components of the device 200. As shown in FIG. 2, the device 200 may include a bus 205, a processor 210, a memory 215, an input component 220, an output component 225, a communication component 230, and/or one or more sensors 235.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215. In some aspects, the controller 110 may include the processor 210 and/or the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system (GPS) sensor, a global navigation satellite system (GNSS) sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The sensor 235 includes one or more devices capable of detecting a characteristic associated with the device 200 (e.g., a characteristic relating to a physical environment of the device 200 or a characteristic relating to a condition of the device 200). The sensor 235 may include one or more photodetectors (e.g., one or more photodiodes), one or more cameras, one or more microphones, one or more gyroscopes (e.g., a micro-electro-mechanical system (MEMS) gyroscope), one or more magnetometers, one or more accelerometers, one or more location sensors (e.g., a GPS or GNSS receiver or a local position system (LPS) device), one or more motion sensors, one or more rotation sensors, one or more pressure sensors, and/or one or more touch sensors, among other examples.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, device 200 may include means for obtaining information indicating a seating configuration for one or more seats of a vehicle; means for determining, in accordance with the seating configuration, that there is a change to an orientation of a seat, of the one or more seats, from a front-facing orientation to a rear-facing orientation or from the rear-facing orientation to the front-facing orientation; means for causing, in accordance with the change to the orientation of the seat, an adjustment of a mapping of audio channels to speakers of the vehicle; means for determining, in accordance with the seating configuration, that the adjustment of the mapping is to cause disagreement between visual content on a display device associated with an additional seat, of the one or more seats, and multiple-channel audio, associated with the visual content, to be output by the speakers; and/or means for causing an adjustment of the visual content on the display device to cause agreement between the visual content and the multiple-channel audio. Additionally, or alternatively, device 200 may include means for obtaining information indicating a seating configuration for one or more seats of a vehicle; means for determining, in accordance with the seating configuration, that there is a change to a directional orientation of a seat of the one or more seats; and means for causing, in accordance with the change to the directional orientation of the seat, an adjustment of a mapping of audio channels to speakers of the vehicle. Additionally, or alternatively, device 200 may include means for obtaining information indicating a seating configuration for one or more seats of a vehicle; means for determining, in accordance with the seating configuration, that there is a disagreement between visual content on a display device associated with a seat, of the one or more seats, and multiple-channel audio associated with the visual content; and means for causing an adjustment of the visual content on the display device to cause agreement between the visual content and the multiple-channel audio. In some aspects, the means for device 200 to perform processes and/or operations described herein may include one or more components of device 200 described in connection with FIG. 2, such as bus 205, processor 210, memory 215, input component 220, output component 225, communication component 230, and/or sensor 235.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

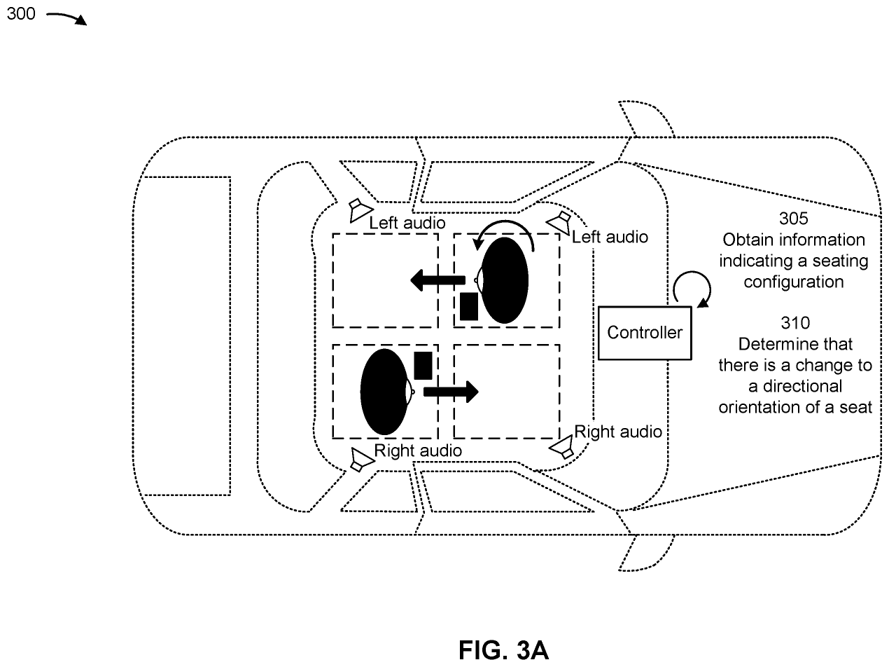

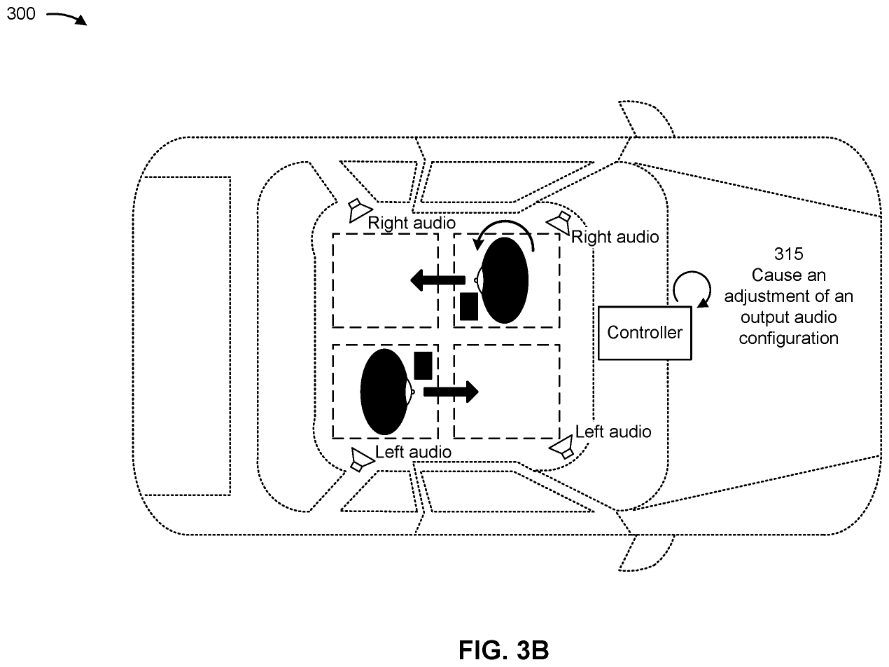

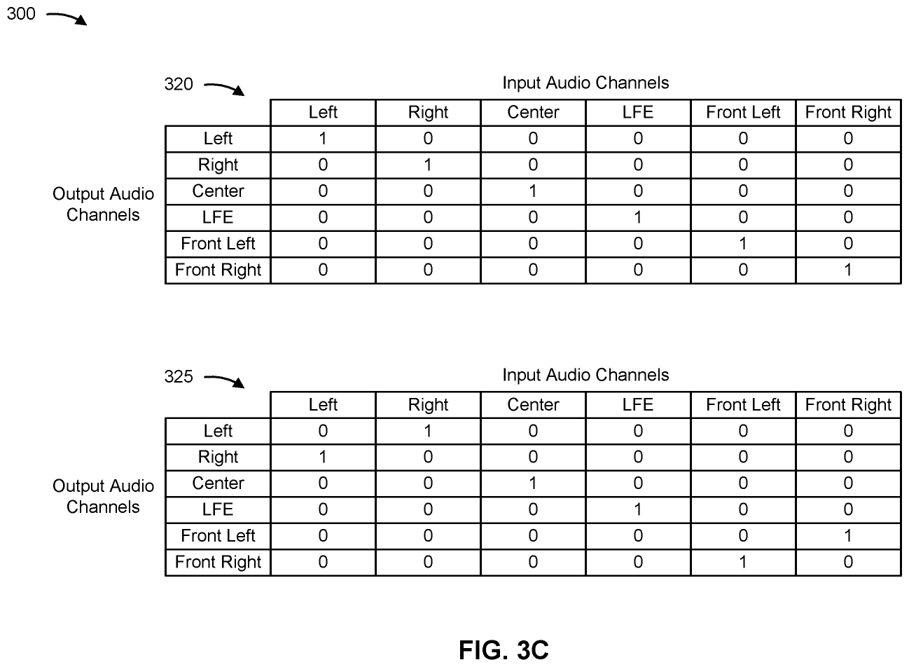

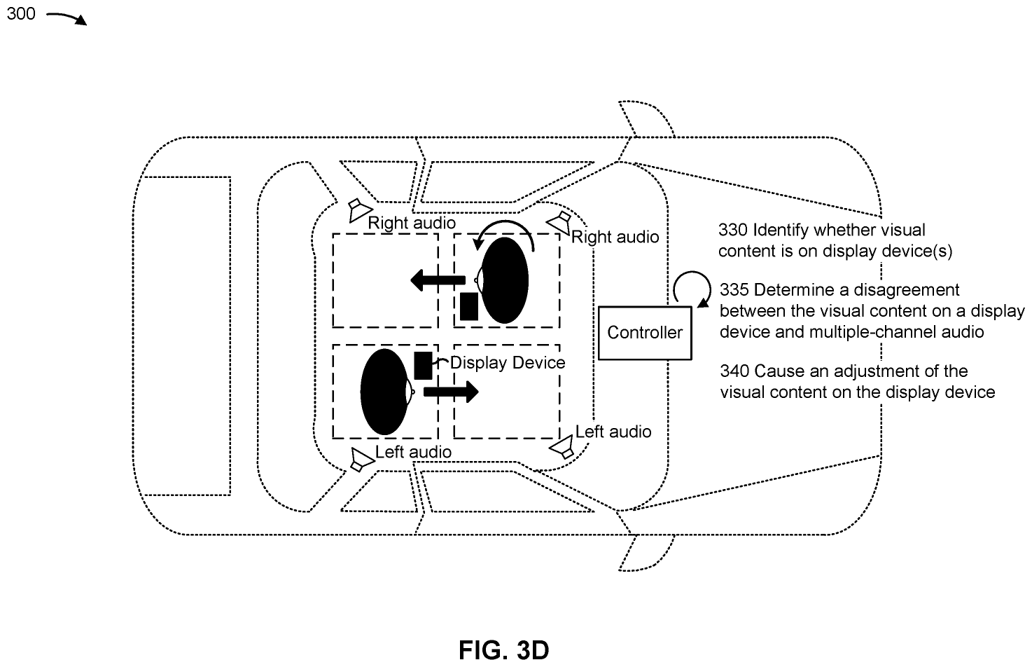

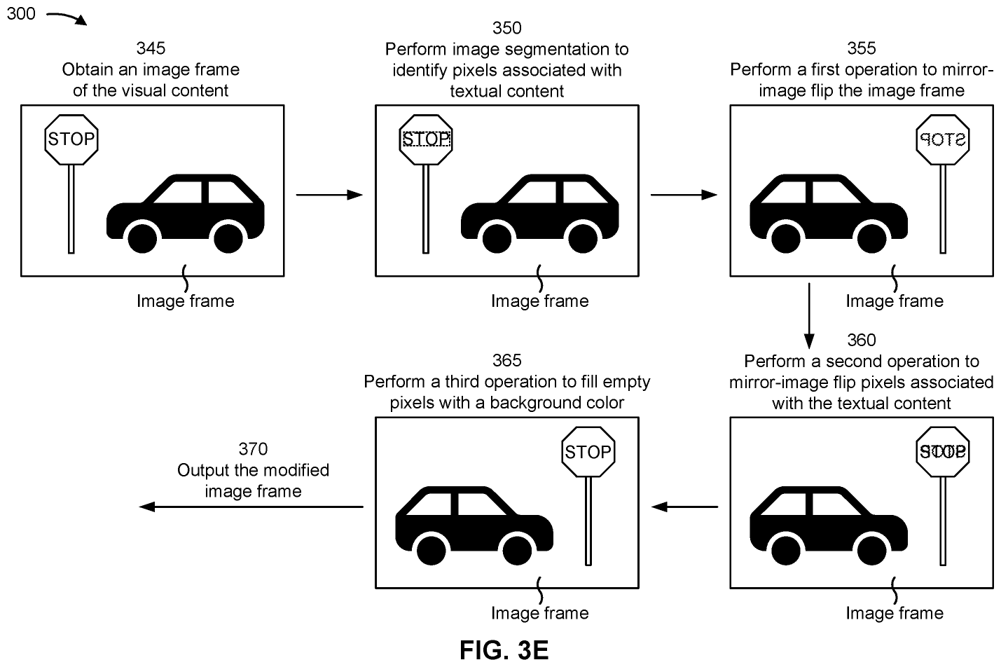

FIGS. 3A-3E are diagrams of an example 300 associated with dynamic audio channel configuration. As shown in FIGS. 3A-3E, example 300 includes a controller (e.g., controller 110). For example, the controller may be an electronic control module. The controller (e.g., one or more processors of the controller) may be configured to perform operations described herein. The controller may be included in a vehicle (e.g., vehicle 100). The vehicle may have a capability of autonomous operation (e.g., fully autonomous operation or semi-autonomous operation), in which operation of the vehicle (e.g., steering, acceleration, speed, braking, and/or navigation, among other examples) is without human involvement. The vehicle may include one or more seats, and a seat of the vehicle may be configured to rotate about a vertical axis (e.g., an axis extending from a floor of the vehicle to a ceiling of the vehicle). Thus, a directional orientation of the seat may be adjusted by rotation of the seat. For example, the seat may be configured to rotate to a front-facing orientation (in which an occupant of the seat is facing a forward travel direction of the vehicle), to a rear-facing orientation (in which an occupant of the seat is facing opposite a forward travel direction of the vehicle), or to a side-facing orientation that is angularly between the front-facing orientation and the rear-facing orientation. Moreover, a seat of the vehicle may include one or more sensors (e.g., seat sensing devices 120) to detect a directional orientation of the seat and/or to detect whether the seat is occupied, and the one or more sensors may be configured to communicate sensor data to the controller.

The vehicle may also include a set of speakers (e.g., audio output devices 130) of an audio system of the vehicle. The set of speakers may have fixed locations in the vehicle (e.g., one or more speakers may be located at the left side of the vehicle, one or more speakers may be located at the right side of the vehicle, and/or one or more speakers may be located at the center of the vehicle, among other examples). The audio system may be capable of multiple-channel audio (e.g., surround sound, such as 5.1.2 surround sound, 7.1.4 surround sound, or 9.1.6 surround sound). The vehicle may further include one or more display devices (e.g., display devices 150) of an infotainment system of the vehicle. In some aspects, a display device may be a floating device, whereby the display device can be freely moved by an occupant of the vehicle, rather than being mounted to a fixed location of the vehicle. The controller may be configured to control the audio system and/or the infotainment system.

As shown in FIG. 3A, and by reference number 305, the controller may obtain information indicating a seating configuration for one or more seats of the vehicle. The seating configuration may indicate directional orientations of the seats (e.g., whether each seat is front-facing, rear-facing, or side-facing) and/or occupancy statuses of the seats (e.g., whether each seat is occupied or unoccupied). The controller may obtain the information indicating the seating configuration from one or more sensors associated with the seats. For example, each seat may include a rotation sensor and/or a pressure sensor, and the controller may obtain sensor data from the rotation sensors and/or pressure sensors of the seats. As another example, the vehicle may include one or more cameras positioned to capture images of an interior of the vehicle, and the controller may obtain image data from the cameras.

In some aspects, the information may include angular positions (e.g., detected by the rotation sensors) for each of the seats to indicate the directional orientations and/or include pressure measurements (e.g., detected by the pressure sensors) for each of the seats to indicate the occupancy statuses. The controller may determine that a seat is occupied responsive to a pressure measurement for the seat satisfying a threshold. In some aspects, the information may include one or more images (e.g., captured by the one or more cameras) that depict directional orientations of the seats and depict the seating locations of occupants of the vehicle. The controller may process the images, using a computer vision technique (e.g., an object recognition technique), to identify the seat directional orientations and/or the seating locations of the occupants.

The controller may obtain the information indicating the seating configuration periodically (e.g., every one second or every 10 seconds). Additionally, or alternatively, the controller may obtain the information indicating the seating configuration responsive to an occurrence of one or more events (e.g., aperiodically). For example, an event may be starting of the vehicle, a change in angular position of a seat, and/or a change in pressure on a seat, among other examples. The controller may determine, in accordance with the seating configuration, a quantity of occupants in the vehicle, the seats of the vehicle that are occupied by the occupants, and/or directional orientations of the seats.

As shown by reference number 310, in accordance with the seating configuration, the controller may determine that there is a change to a directional orientation of a seat of the vehicle (e.g., a change that would result in a current mapping of audio channels to speakers being in disagreement with the seating configuration, as described herein). For example, the controller may determine, in accordance with the seating configuration, that there is a change to an orientation of the seat from a first orientation to a second orientation. As an example, the controller may determine, in accordance with the seating configuration, that there is a change to an orientation of the seat from a front-facing orientation to a rear-facing orientation, or from a rear-facing orientation to a front-facing orientation (e.g., the seat has rotated 180 degrees). In some aspects, the controller may determine the change of the seat's orientation by comparing the seating configuration to a preceding seating configuration. In some aspects, the controller may determine the change of the seat's orientation responsive to receiving the seating configuration (e.g., when the seating configuration is transmitted to the controller responsive to an occurrence of one or more events, as described herein).

As shown in FIG. 3B, and by reference number 315, in accordance with the change to the directional orientation of the seat, the controller may cause an adjustment of an output audio configuration. For example, in accordance with the change to the directional orientation of the seat, the controller may cause an adjustment of a mapping of audio channels to speakers. The audio channels may include at least a left-side audio channel intended for a left-side speaker of the vehicle with respect to a forward travel direction of the vehicle, and a right-side audio channel intended for a right-side speaker of the vehicle with respect to the forward travel direction of the vehicle. In one example, to cause the adjustment of the mapping, the controller may cause the left-side audio channel to be mapped to the right-side speaker and the right-side audio channel to be mapped to the left-side speaker (e.g., when the change to the orientation of the seat is from a front-facing orientation to a rear-facing orientation). Thus, the adjustment to the mapping may follow the change of the seat's directional orientation to maintain or restore agreement between an output of the audio system and an occupant's position and orientation in the vehicle.

Additionally, or alternatively, to cause the adjustment of the mapping, the controller may cause (e.g., at a processor, included in the controller or separate from the controller, that uses a reduced instruction set computer (RISC) architecture (e.g., an ARM processor)) adjustment of an order (e.g., a re-ordering) of a content of an audio buffer. For example, the order of the content (e.g., which includes audio data for the multiple audio channels) may be adjusted so that audio data associated with a particular audio channel is provided to a desired speaker (e.g., in accordance with the adjustment to the mapping). The controller may adjust the order of the content of the audio buffer during or after post-processing of the audio data (e.g., surround sound post-processing, adding audio effects, equalization, or the like). In one example (e.g., for 5.1 channel surround sound), if an audio buffer content is ordered as {left-side audio channel, right-side audio channel, center audio channel, low frequency effect (LFE) audio channel, front-left audio channel, front-right audio channel}, then the input audio buffer content may be re-ordered as {right-side audio channel, left-side audio channel, center audio channel, LFE audio channel, front-right audio channel, front-left audio channel}.

In some aspects, to cause adjustment of the mapping, the controller may cause updating of an audio input-output matrix used by an audio hardware abstraction layer (e.g., software that controls the speakers). For example, the controller may cause updating of weighting coefficients of the matrix. The updated matrix may be used by a digital signal processor (DSP), included in the controller or separate from the controller, to derive output audio channels that are provided to the speakers.

As shown in FIG. 3C, matrices 320 and 325 provide an example of adjustment of the mapping of audio channels to speakers (e.g., for 5.1 channel surround sound). In matrices 320 and 325 columns may represent input audio channels (e.g., received from an audio application) and rows may represent output audio channels (e.g., provided to speakers). A “0” value at an intersection of a column and a row may indicate that the input audio channel of the column is not mapped to the output audio channel of the row, whereas a “1” at the intersection may indicate that the input audio channel is mapped to the output audio channel. Matrix 320 may be used when the seat is in a front-facing orientation. As shown in matrix 320, a left-side input audio channel may be mapped to a left-side output audio channel, a right-side input audio channel may be mapped to a right-side output audio channel, a front-left input audio channel may be mapped to a front-left output audio channel, and a front-right input audio channel may be mapped to a front-right output audio channel. Matrix 325 shows an adjustment when the seat is changed to a rear-facing orientation. As shown in matrix 325, a left-side input audio channel may be mapped to a right-side output audio channel, a right-side input audio channel may be mapped to a left-side output audio channel, a front-left input audio channel may be mapped to a front-right output audio channel, and a front-right input audio channel may be mapped to a front-left output audio channel.

By causing the adjustment of the mapping of audio channels to speakers, the controller may cause multiple-channel audio output by the speakers to be altered in accordance with the mapping. For example, the controller may cause audio signals to be provided to the speakers (e.g., via a digital to analog converter) in accordance with the mapping. In this way, the controller may dynamically control an audio channel configuration, so that the multiple-channel audio output by the speakers is in agreement with the directional orientation of the seat. In some aspects, causing the adjustment of the output audio configuration may include adjusting an output volume (e.g., in addition, or alternatively, to adjusting the mapping).

As shown in FIG. 3D, and by reference number 330, the controller may identify whether visual content (e.g., video or a video game) is on one or more display devices (e.g., tablet computers) of the vehicle. For example, the controller may identify, in accordance with information of the infotainment system, whether each display device of the vehicle is presenting the visual content or not presenting the visual content. Moreover, each display device may be associated with a respective seat of the vehicle (e.g., mounted to the seat or freely movable by an occupant of the seat). Thus, the controller may also identify which seats have occupants that are viewing the visual content. The same visual content may be on each display device that is presenting visual content, and multiple-channel audio associated with the visual content may be output by the speakers (e.g., the occupants of the vehicle may separately view the visual content on respective display devices, but commonly listen to the multiple-channel audio through the speakers of the vehicle). In one example, the visual content may be video (e.g., a movie), and the multiple-channel audio may be surround sound audio (e.g., that includes surround sound effects, such as audio panning) associated with the video.

As shown by reference number 335, the controller may determine, in accordance with the seating configuration, that there is disagreement between the visual content on a display device (e.g., one or more display devices) associated with a seat and the multiple-channel audio, associated with the visual content, to be output by the speakers (e.g., from the perspective of a user of the display device). For example, the controller may determine, in accordance with the seating configuration, that the adjustment of the mapping of audio channels to speakers is to cause disagreement between the visual content on the display device and the multiple-channel audio. The disagreement may refer to the multiple-channel audio being unsynchronized (e.g., directionally dissonant) with the visual content on the display device from the perspective of an occupant of the vehicle that is using (e.g., viewing) the display device.

The controller may determine that there is the disagreement if the same visual content, with accompanying multiple-channel audio output by the speakers, is on a first display device and on a second display device associated with respective seats that are facing in different directions (e.g., one seat is forward facing and one seat is rear facing). For example, if an occupant A has rotated a front seat to face an occupant B in a rear seat, and if the mapping of the audio channels to speakers was adjusted in accordance with the rotation of the front seat, then occupant B may perceive the multiple-channel audio as being unsynchronized with the visual content on a display device of occupant B. As an example, for a scene in a movie where an airplane flies from the left side of the screen to the right side of the screen, occupant B may perceive audio panning from right to left based on the adjusted mapping.

As shown by reference number 340, the controller may cause an adjustment of the visual content on the display device experiencing the disagreement. For example, the adjustment of the visual content may be flipping of the visual content. As an example, flipping of the visual content may be a horizontal, mirror-image flip of the visual content. Thus, one or more first display devices of the vehicle may present the flipped visual content and one or more second display devices of the vehicle may present the visual content unflipped (e.g., in the visual content's original orientation). Adjusting the visual content may cause agreement between the visual content and the multiple-channel audio for the display device previously experiencing disagreement. In this way, all display devices of the vehicle may present the visual content in a manner that agrees with the multiple-channel audio, from the perspective of the occupants using the display devices, even if one or more seats of the vehicle have been rotated.

In some examples, the visual content may include textual content (e.g., words, numbers, subtitles, or the like). In some aspects, to cause the adjustment of the visual content, the controller may cause flipping of the visual content except for textual content of the visual content. Stated differently, non-textual content of the visual content may be flipped, and textual content of the visual content may be unflipped. FIG. 3E shows example operations for flipping visual content (e.g., video) without flipping textual content. In some aspects, flipping visual content without flipping textual content may be performed using one or more additional operations, one or more alternative operations, and/or operations in a different order from those shown in FIG. 3E.

As shown by reference number 345, the controller may obtain (e.g., extract) an image frame (e.g., a video frame) of the visual content. As shown by reference number 350, the controller may perform image segmentation (e.g., using a computer vision technique) on the image frame to identify pixels of the image frame associated with textual content (e.g., text regions of interest). For example, the controller may perform image segmentation to divide the image frame into a plurality of segments, and one or more segments may include pixels associated with textual content.

As shown by reference number 355, the controller may perform a first operation (e.g., a first image processing operation) to mirror-image flip the image frame. The first operation may include a flip of the entire image frame. Thus, the first operation may result in mirror-image flipping of the textual content in the image frame, in addition to mirror-image flipping of the non-textual content in the image frame. As shown by reference number 360, the controller may perform a second operation (e.g., a second image processing operation) to mirror-image flip the pixels associated with the textual content (if any). The second operation may result in one or more empty pixels of the image frame (e.g., pixels that have no assigned color value).

As shown by reference number 365, the controller may perform a third operation (e.g., a third image processing operation) to fill the empty pixels with a background color. The background color may be the same across image segments, or may be particular to an image segment. In some aspects, the controller may identify the background color (e.g., of the entire image frame, or of a segment of the image frame) using one or more background color detection techniques. As shown by reference number 370, the controller may output the modified image frame (e.g., to the infotainment system or another display sub-system) for presentation on the display device. The controller may perform the operations shown in FIG. 3E for multiple image frames (e.g., each image frame) of the visual content. In some aspects, the controller may cause the display device to perform one or more of the operations shown in FIG. 3E.

In addition, or alternatively, to the adjustment of the visual content as described above, the controller may perform one or more other operations to handle, resolve, or prevent conflicts between multiple occupants of the vehicle. In some aspects, a particular display device (e.g., associated with a driver's seat) may be designated as a control device for the infotainment system of the vehicle. The control device may be enabled to provide vehicle-wide settings for the infotainment system (e.g., whereas other display devices may not be enabled to do so). The controller may receive, from the control device, an indication of a designated occupant of the vehicle, or a designated seat of the vehicle, that is to be given preference for the audio system. Thus, the controller may cause the adjustment of the mapping of audio channels to speakers responsive to the change to the directional orientation of the designated seat. However, the controller may refrain from adjusting the mapping when there is a change to a directional orientation of a non-designated seat. In some aspects, the controller may use a default designated seat (e.g., the driver's seat or the seat associated with the control device) if no designated seat is indicated to the controller.

In some aspects, the controller may cause the adjustment of the mapping of audio channels to speakers, only with respect to a first subset of speakers associated with a first seat of the vehicle, responsive to a change to a directional orientation of the first seat. Furthermore, the controller may cause the adjustment of the mapping of audio channels to speakers, only with respect to a second subset of speakers associated with a second seat of the vehicle, responsive to a change to a directional orientation of the second seat. For example, the first subset of speakers may be mounted on, or directed at, a driver's seat of the vehicle, and the second subset of speakers may be mounted on, or directed at, a front-passenger seat of the vehicle. Continuing with the example, responsive to a change to a directional orientation of the driver's seat, the controller may adjust the mapping with respect to the first subset of speakers (but not with respect to the second subset of speakers or an additional subset of speakers, such as speakers mounted on, or directed at a back seat of the vehicle), and responsive to a change to a directional orientation of the front passenger's seat, the controller may adjust the mapping with respect to the second subset of speakers (but not with respect to the first subset of speakers or the additional subset of speakers).

In some aspects, the controller may select the speakers for a subset of speakers in accordance with the seating configuration. For example, if the vehicle has a single occupant in a front seating row of the vehicle and a single occupant in a rear seating row of the vehicle, then the controller may select all front-located speakers as a first subset of speakers and all back-located speakers as a second subset of speakers. However, if the vehicle has two occupants in the front seating row, then the controller may select a portion of the front-located speakers as the first subset of speakers. In some aspects, the controller may automatically implement the controller's selection of subsets of speakers. In some aspects, the controller may provide, to the control device, a recommendation indicating the controller's selection of subsets of speakers, and an occupant of the vehicle may use the control device to accept the recommendation or adjust the recommendation.

In some aspects, the controller may refrain from making an adjustment to a mapping of audio channels to speakers, in response to a change to a directional orientation of a seat, in accordance with a determination that there is at least one occupant in a front seating row of the vehicle and at least one occupant in a rear seating row of the vehicle (e.g., the controller may disable dynamic audio channel configuration). In some aspects, the controller may make an adjustment to a mapping of audio channels to speakers responsive to a change to a directional orientation of a seat, and in accordance with a determination that a display device associated with the seat is presenting visual content (e.g., video or a video game) associated with multiple-channel audio being output by the speakers and that no other display device is presenting visual content associated with multiple-channel audio being output by the speakers. For example, if an occupant A's display device is playing video with associated audio being output by the speakers, and if an occupant B's display device is not playing the video, then the controller may make an adjustment to a mapping of audio channels to speakers responsive to a change to a directional orientation of occupant A's seat (but not responsive to a change to a directional orientation of occupant B's seat).

In some aspects, the speakers may have a capability of audio beamforming. In some aspects, the controller may cause (e.g., by adjusting a mapping of audio channels to speakers, as described herein) a first subset of speakers to beamform audio directed at one or more first seats of the vehicle and cause a second subset of speakers to beamform audio directed at one or more second seats of the vehicle. For example, the controller may cause left-side speakers of the vehicle to beamform audio directed at a front seating row of the vehicle and cause right-side speakers of the vehicle to beamform audio directed at a rear seating row of the vehicle. This may be useful when seats of the front seating row have been rotated to face seats of the rear seating row. In this way, separate multiple-channel audio (e.g., stereo audio or surround sound audio) may be provided for respective occupants of the vehicle.

As indicated above, FIGS. 3A-3E are provided as an example. Other examples may differ from what is described with regard to FIGS. 3A-3E.

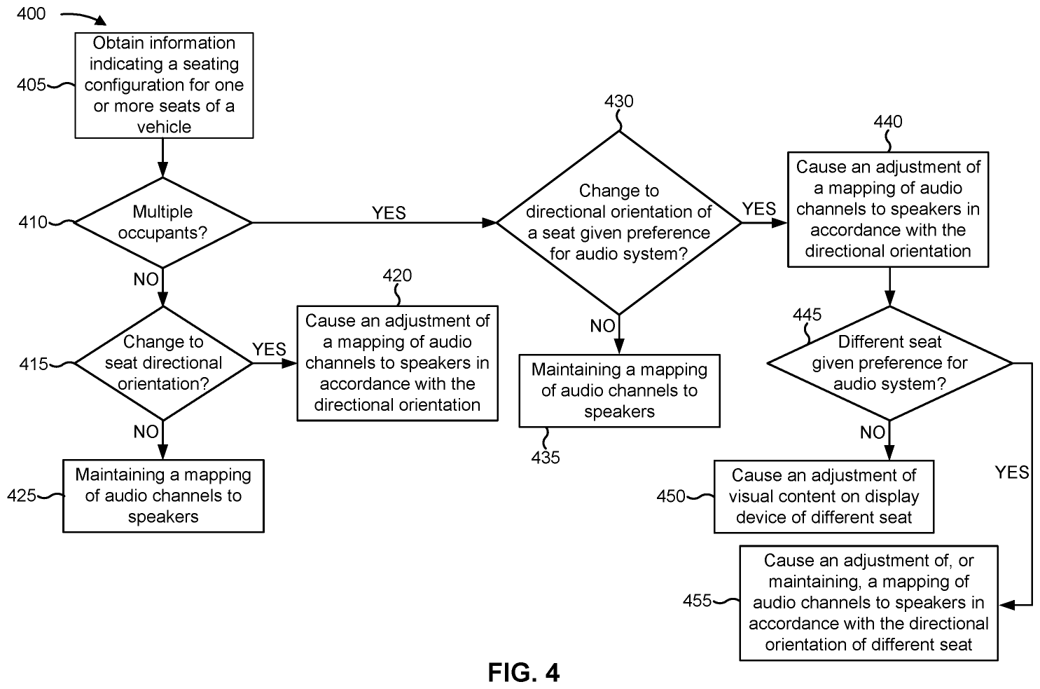

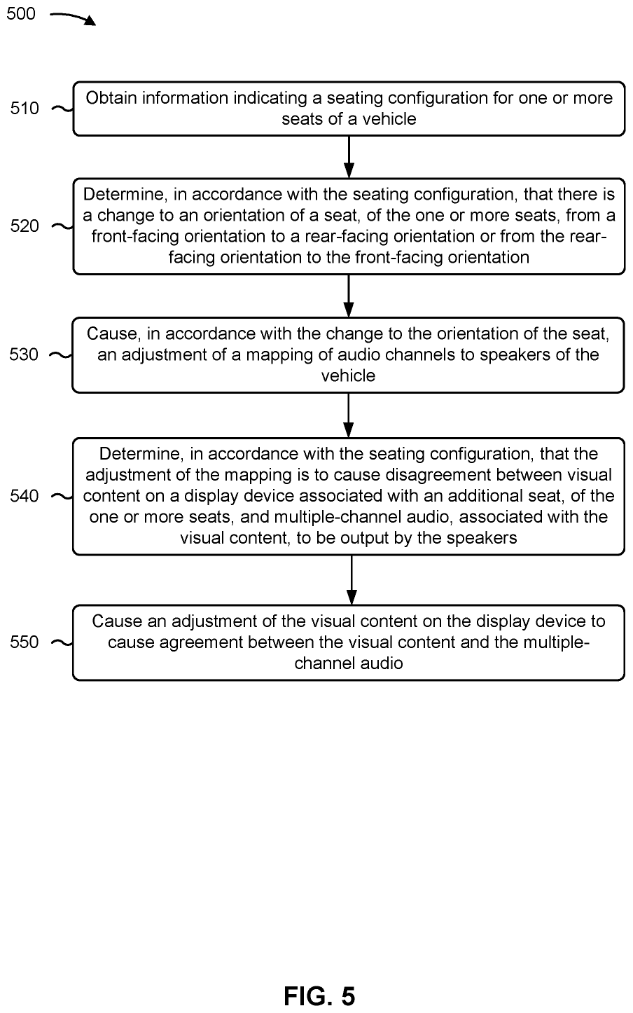

FIG. 4 is a flowchart of an example process 400 associated with dynamic audio channel configuration. In some aspects, one or more process blocks of FIG. 4 are performed by a controller (e.g., controller 110). In some aspects, one or more process blocks of FIG. 4 are performed by another device or a group of devices separate from or including the controller, such as a seat sensing device (e.g., seat sensing device 120), an audio output device (e.g., audio output device 130), and/or a display device (e.g., display device 150). Additionally, or alternatively, one or more process blocks of FIG. 5 may be performed by one or more components of device 200, such as processor 210, memory 215, input component 220, output component 225, communication component 230, and/or sensor 235.

As shown in FIG. 4, process 400 may include obtaining information indicating a seating configuration for one or more seats of a vehicle (block 405), as described herein. Process 400 may include determining, in accordance with the seating configuration, whether the vehicle has multiple occupants (block 410). Responsive to a determination that the vehicle does not have multiple occupants (block 410—NO), process 400 may include determining, in accordance with the seating configuration, whether there is a change to a directional orientation of a seat (block 415), as described herein. Responsive to a determination that there is a change to the directional orientation of the seat (block 415—YES), process 400 may include causing an adjustment of a mapping of audio channels to speakers of the vehicle in accordance with the directional orientation of the seat (block 420), as described herein. Responsive to a determination that there is not a change to the directional orientation of the seat (block 415—NO), process 400 may including maintaining a mapping (e.g., a default mapping or a previously adjusted mapping) of audio channels to speakers of the vehicle (block 425).

Responsive to a determination that the vehicle does have multiple occupants (block 410—YES), process 400 may include determining, in accordance with the seating configuration, whether there is a change to a directional orientation of a seat, that is designated to be given preference for an audio system, resulting in seats that are facing in different directions (block 430), as described herein. For example, the change to the directional orientation of the seat may result in one seat of the vehicle having a forward-facing orientation and one seat of the vehicle having a rear-facing orientation. Responsive to a determination that there is not such a change to the directional orientation of the seat designated to be given preference for the audio system (block 430—NO), process 400 may include maintaining a mapping (e.g., a default mapping or a previously adjusted mapping) of audio channels to speakers of the vehicle (block 435). Responsive to a determination that there is such a change to the directional orientation of the seat designated to be given preference for the audio system (block 430—YES), process 400 may include causing an adjustment of a mapping of audio channels to speakers of the vehicle in accordance with the directional orientation of the designated seat (block 440), as described herein.

Process 400 may include determining whether a different seat (e.g., facing the designated seat and/or having a directional orientation opposite to that of the designated seat) is being designated to be given preference for the audio system (block 445). For example, an occupant of the different seat, via a display device, may request to be given preference, and an occupant of the designated seat, via a display device, may grant or deny the request. Responsive to a determination that the different seat is not being designated to be given preference (block 445—NO), process 400 may include causing an adjustment (e.g., flipping) of visual content on a display device associated with the different seat (block 450), as described herein. Responsive to a determination that the different seat is being designated to be given preference (block 445—YES), process 400 may include causing an adjustment of, or maintaining, a mapping of audio channels to speakers of the vehicle in accordance with the directional orientation of the different seat (block 455), as described herein. In some aspects, responsive to adjusting the mapping of audio channels to speakers of the vehicle in accordance with the directional orientation of the different seat, process 400 may include causing an adjustment (e.g., flipping) of visual content on a display device associated with the original designated seat.

As indicated above, FIG. 4 is provided as an example. Other examples may differ from what is described with regard to FIG. 4.

FIG. 5 is a flowchart of an example process 500 associated with dynamic audio channel configuration for a vehicle. In some aspects, one or more process blocks of FIG. 5 are performed by a controller (e.g., controller 110). In some aspects, one or more process blocks of FIG. 5 are performed by another device or a group of devices separate from or including the controller, such as a seat sensing device (e.g., seat sensing device 120), an audio output device (e.g., audio output device 130), and/or a display device (e.g., display device 150). Additionally, or alternatively, one or more process blocks of FIG. 5 may be performed by one or more components of device 200, such as processor 210, memory 215, input component 220, output component 225, communication component 230, and/or sensor 235.

As shown in FIG. 5, process 500 may include obtaining information indicating a seating configuration for one or more seats of a vehicle (block 510). For example, the controller may obtain information indicating a seating configuration for one or more seats of a vehicle, as described above.

As further shown in FIG. 5, process 500 may include determining, in accordance with the seating configuration, that there is a change to an orientation of a seat, of the one or more seats, from a front-facing orientation to a rear-facing orientation or from the rear-facing orientation to the front-facing orientation (block 520). For example, the controller may determine, in accordance with the seating configuration, that there is a change to an orientation of a seat, of the one or more seats, from a front-facing orientation to a rear-facing orientation or from the rear-facing orientation to the front-facing orientation, as described above.

As further shown in FIG. 5, process 500 may include causing, in accordance with the change to the orientation of the seat, an adjustment of a mapping of audio channels to speakers of the vehicle (block 530). For example, the controller may cause, in accordance with the change to the orientation of the seat, an adjustment of a mapping of audio channels to speakers of the vehicle, as described above.

As further shown in FIG. 5, process 500 may include determining, in accordance with the seating configuration, that the adjustment of the mapping is to cause disagreement between visual content on a display device associated with an additional seat, of the one or more seats, and multiple-channel audio, associated with the visual content, to be output by the speakers (block 540). For example, the controller may determine, in accordance with the seating configuration, that the adjustment of the mapping is to cause disagreement between visual content on a display device associated with an additional seat, of the one or more seats, and multiple-channel audio, associated with the visual content, to be output by the speakers, as described above.

As further shown in FIG. 5, process 500 may include causing an adjustment of the visual content on the display device to cause agreement between the visual content and the multiple-channel audio (block 550). For example, the controller may cause an adjustment of the visual content on the display device to cause agreement between the visual content and the multiple-channel audio, as described above.

Process 500 may include additional aspects, such as any single aspect or any combination of aspects described below and/or in connection with one or more other processes described elsewhere herein.

In a first aspect, the seating configuration indicates at least one of directional orientations of the one or more seats or occupancy statuses of the one or more seats.

In a second aspect, alone or in combination with the first aspect, causing the adjustment of the mapping includes causing a left-side audio channel intended for a left-side speaker of the vehicle to be mapped to a right-side speaker of the vehicle and a right-side audio channel intended for the right-side speaker of the vehicle to be mapped to the left-side speaker of the vehicle.

In a third aspect, alone or in combination with one or more of the first and second aspects, causing the adjustment of the mapping includes causing adjusting of an order of a content of an audio buffer.

In a fourth aspect, alone or in combination with one or more of the first through third aspects, causing the adjustment of the mapping includes causing updating of an audio input-output matrix used by an audio hardware abstraction layer.

In a fifth aspect, alone or in combination with one or more of the first through fourth aspects, causing the adjustment of the visual content includes causing flipping of the visual content except for textual content of the visual content.

In a sixth aspect, alone or in combination with one or more of the first through fifth aspects, causing the adjustment of the visual content includes performing image segmentation on an image frame of the visual content to identify pixels of the image frame associated with textual content, performing a first operation to mirror-image flip the image frame, the first operation to result in mirror-image flipping of the textual content, performing a second operation to mirror-image flip the pixels associated with the textual content, the second operation to result in one or more empty pixels of the image frame, and performing a third operation to fill the empty pixels with a background color.

In a seventh aspect, alone or in combination with one or more of the first through sixth aspects, the vehicle has a capability of autonomous operation.

In an eighth aspect, alone or in combination with one or more of the first through seventh aspects, the speakers include at least a left-side speaker of the vehicle and a right-side speaker of the vehicle.

In a ninth aspect, alone or in combination with one or more of the first through eighth aspects, the information indicating the seating configuration is obtained from one or more sensors associated with the one or more seats of the vehicle.

In a tenth aspect, alone or in combination with one or more of the first through ninth aspects, process 500 includes receiving an indication of a designated seat of the vehicle, where the adjustment of the mapping of the audio channels to the speakers is responsive to the seat being the designated seat.

In an eleventh aspect, alone or in combination with one or more of the first through tenth aspects, the adjustment of the mapping of the audio channels to the speakers is only with respect to a subset of speakers associated with the seat.

Although FIG. 5 shows example blocks of process 500, in some aspects, process 500 includes additional blocks, fewer blocks, different blocks, or differently arranged blocks than those depicted in FIG. 5. Additionally, or alternatively, two or more of the blocks of process 500 may be performed in parallel.

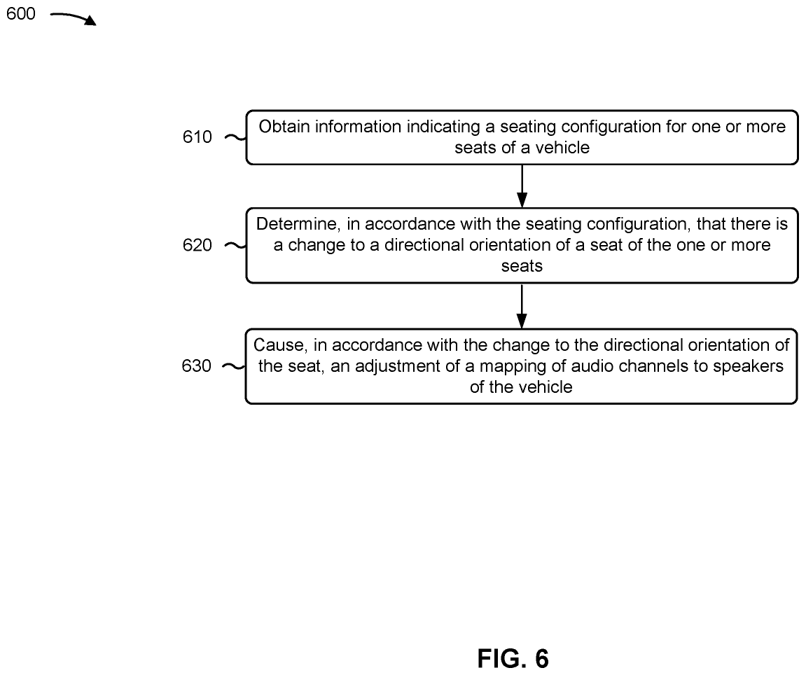

FIG. 6 is a flowchart of an example process 600 associated with dynamic audio channel configuration for a vehicle. In some aspects, one or more process blocks of FIG. 6 are performed by a controller (e.g., controller 110). In some aspects, one or more process blocks of FIG. 6 are performed by another device or a group of devices separate from or including the controller, such as a seat sensing device (e.g., seat sensing device 120), an audio output device (e.g., audio output device 130), and/or a display device (e.g., display device 150). Additionally, or alternatively, one or more process blocks of FIG. 5 may be performed by one or more components of device 200, such as processor 210, memory 215, input component 220, output component 225, communication component 230, and/or sensor 235.

As shown in FIG. 6, process 600 may include obtaining information indicating a seating configuration for one or more seats of a vehicle (block 610). For example, the controller may obtain information indicating a seating configuration for one or more seats of a vehicle, as described above.

As further shown in FIG. 6, process 600 may include determining, in accordance with the seating configuration, that there is a change to a directional orientation of a seat of the one or more seats (block 620). For example, the controller may determine, in accordance with the seating configuration, that there is a change to a directional orientation of a seat of the one or more seats, as described above.

As further shown in FIG. 6, process 600 may include causing, in accordance with the change to the directional orientation of the seat, an adjustment of a mapping of audio channels to speakers of the vehicle (block 630). For example, the controller may cause, in accordance with the change to the directional orientation of the seat, an adjustment of a mapping of audio channels to speakers of the vehicle, as described above.

Process 600 may include additional aspects, such as any single aspect or any combination of aspects described below and/or in connection with one or more other processes described elsewhere herein.

In a first aspect, the seating configuration indicates at least one of directional orientations of the one or more seats or occupancy statuses of the one or more seats.

In a second aspect, alone or in combination with the first aspect, process 600 includes causing a left-side audio channel intended for a left-side speaker of the vehicle to be mapped to a right-side speaker of the vehicle and a right-side audio channel intended for the right-side speaker of the vehicle to be mapped to the left-side speaker of the vehicle.

In a third aspect, alone or in combination with one or more of the first and second aspects, process 600 includes causing adjusting of an order of a content of an audio buffer.

In a fourth aspect, alone or in combination with one or more of the first through third aspects, process 600 includes causing updating of an audio input-output matrix used by an audio hardware abstraction layer.

In a fifth aspect, alone or in combination with one or more of the first through fourth aspects, the speakers include at least a left-side speaker of the vehicle and a right-side speaker of the vehicle.

In a sixth aspect, alone or in combination with one or more of the first through fifth aspects, process 600 includes obtaining the information indicating the seating configuration from one or more sensors associated with the one or more seats of the vehicle.

In a seventh aspect, alone or in combination with one or more of the first through sixth aspects, process 600 includes receiving an indication of a designated seat of the vehicle, where the adjustment of the mapping of the audio channels to the speakers is responsive to the seat being the designated seat.

In an eighth aspect, alone or in combination with one or more of the first through seventh aspects, the adjustment of the mapping of the audio channels to the speakers is only with respect to a subset of speakers associated with the seat.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

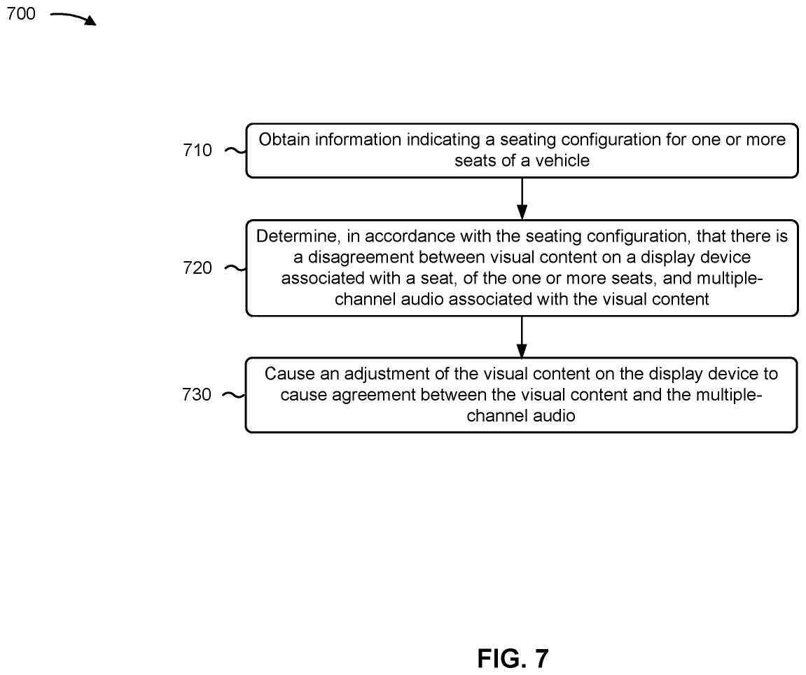

FIG. 7 is a flowchart of an example process 700 associated with dynamic audio channel configuration for a vehicle. In some aspects, one or more process blocks of FIG. 6 are performed by a controller (e.g., controller 110). In some aspects, one or more process blocks of FIG. 6 are performed by another device or a group of devices separate from or including the controller, such as a seat sensing device (e.g., seat sensing device 120), an audio output device (e.g., audio output device 130), and/or a display device (e.g., display device 150). Additionally, or alternatively, one or more process blocks of FIG. 5 may be performed by one or more components of device 200, such as processor 210, memory 215, input component 220, output component 225, communication component 230, and/or sensor 235.

As shown in FIG. 7, process 700 may include obtaining information indicating a seating configuration for one or more seats of a vehicle (block 710). For example, the controller may obtain information indicating a seating configuration for one or more seats of a vehicle, as described above.

As further shown in FIG. 7, process 700 may include determining, in accordance with the seating configuration, that there is a disagreement between visual content on a display device associated with a seat, of the one or more seats, and multiple-channel audio associated with the visual content (block 720). For example, the controller may determine, in accordance with the seating configuration, that there is a disagreement between visual content on a display device associated with a seat, of the one or more seats, and multiple-channel audio associated with the visual content, as described above.

As further shown in FIG. 7, process 700 may include causing an adjustment of the visual content on the display device to cause agreement between the visual content and the multiple-channel audio (block 730). For example, the controller may cause an adjustment of the visual content on the display device to cause agreement between the visual content and the multiple-channel audio, as described above.

Process 700 may include additional aspects, such as any single aspect or any combination of aspects described below and/or in connection with one or more other processes described elsewhere herein.

In a first aspect, the seating configuration indicates at least one of directional orientations of the one or more seats or occupancy statuses of the one or more seats.

In a second aspect, alone or in combination with the first aspect, causing the adjustment of the visual content includes causing flipping of the visual content except for textual content of the visual content.

In a third aspect, alone or in combination with one or more of the first and second aspects, causing the adjustment of the visual content includes performing image segmentation on an image frame of the visual content to identify pixels of the image frame associated with textual content, performing a first operation to mirror-image flip the image frame, the first operation to result in mirror-image flipping of the textual content, performing a second operation to mirror-image flip the pixels associated with the textual content, the second operation to result in one or more empty pixels of the image frame, and performing a third operation to fill the empty pixels with a background color.

In a fourth aspect, alone or in combination with one or more of the first through third aspects, process 700 includes obtaining the information indicating the seating configuration from one or more sensors associated with the one or more seats of the vehicle.

Although FIG. 7 shows example blocks of process 700, in some aspects, process 700 includes additional blocks, fewer blocks, different blocks, or differently arranged blocks than those depicted in FIG. 7. Additionally, or alternatively, two or more of the blocks of process 700 may be performed in parallel.

The following provides an overview of some Aspects of the present disclosure:

Aspect 1: A method, comprising: obtaining, by a device, information indicating a seating configuration for one or more seats of a vehicle; determining, by the device and in accordance with the seating configuration, that there is a change to an orientation of a seat, of the one or more seats, from a front-facing orientation to a rear-facing orientation or from the rear-facing orientation to the front-facing orientation; causing, by the device and in accordance with the change to the orientation of the seat, an adjustment of a mapping of audio channels to speakers of the vehicle; determining, by the device and in accordance with the seating configuration, that the adjustment of the mapping is to cause disagreement between visual content on a display device associated with an additional seat, of the one or more seats, and multiple-channel audio, associated with the visual content, to be output by the speakers; and causing, by the device, an adjustment of the visual content on the display device to cause agreement between the visual content and the multiple-channel audio.

Aspect 2: The method of Aspect 1, wherein the seating configuration indicates at least one of directional orientations of the one or more seats or occupancy statuses of the one or more seats.

Aspect 3: The method of any of Aspects 1-2, wherein causing the adjustment of the mapping comprises: causing a left-side audio channel intended for a left-side speaker of the vehicle to be mapped to a right-side speaker of the vehicle and a right-side audio channel intended for the right-side speaker of the vehicle to be mapped to the left-side speaker of the vehicle.

Aspect 4: The method of any of Aspects 1-3, wherein causing the adjustment of the mapping comprises: causing adjusting of an order of a content of an audio buffer.

Aspect 5: The method of any of Aspects 1-4, wherein causing the adjustment of the mapping comprises: causing updating of an audio input-output matrix used by an audio hardware abstraction layer.

Aspect 6: The method of any of Aspects 1-5, wherein causing the adjustment of the visual content comprises: causing flipping of the visual content except for textual content of the visual content.

Aspect 7: The method of any of Aspects 1-6, wherein causing the adjustment of the visual content comprises: performing image segmentation on an image frame of the visual content to identify pixels of the image frame associated with textual content; performing a first operation to mirror-image flip the image frame, the first operation to result in mirror-image flipping of the textual content; performing a second operation to mirror-image flip the pixels associated with the textual content, the second operation to result in one or more empty pixels of the image frame; and performing a third operation to fill the empty pixels with a background color.

Aspect 8: The method of any of Aspects 1-7, wherein the vehicle has a capability of autonomous operation.

Aspect 9: The method of any of Aspects 1-8, wherein the speakers include at least a left-side speaker of the vehicle and a right-side speaker of the vehicle.

Aspect 10: The method of any of Aspects 1-9, wherein the information indicating the seating configuration is obtained from one or more sensors associated with the one or more seats of the vehicle.

Aspect 11: The method of any of Aspects 1-10, further comprising: receiving an indication of a designated seat of the vehicle, wherein the adjustment of the mapping of the audio channels to the speakers is responsive to the seat being the designated seat.

Aspect 12: The method of any of Aspects 1-11, wherein the adjustment of the mapping of the audio channels to the speakers is only with respect to a subset of speakers associated with the seat.

Aspect 13: A controller, comprising: one or more memories; and one or more processors, coupled to the one or more memories, configured to: obtain information indicating a seating configuration for one or more seats of a vehicle; determine, in accordance with the seating configuration, that there is a change to a directional orientation of a seat of the one or more seats; and cause, in accordance with the change to the directional orientation of the seat, an adjustment of a mapping of audio channels to speakers of the vehicle.

Aspect 14: The controller of Aspect 13, wherein the seating configuration indicates at least one of directional orientations of the one or more seats or occupancy statuses of the one or more seats.

Aspect 15: The controller of any of Aspects 13-14, wherein the one or more processors, to cause the adjustment of the mapping, are configured to: cause a left-side audio channel intended for a left-side speaker of the vehicle to be mapped to a right-side speaker of the vehicle and a right-side audio channel intended for the right-side speaker of the vehicle to be mapped to the left-side speaker of the vehicle.

Aspect 16: The controller of any of Aspects 13-15, wherein the one or more processors, to cause the adjustment of the mapping, are configured to: cause adjusting of an order of a content of an audio buffer.

Aspect 17: The controller of any of Aspects 13-16, wherein the one or more processors, to cause the adjustment of the mapping, are configured to: cause updating of an audio input-output matrix used by an audio hardware abstraction layer.

Aspect 18: The controller of any of Aspects 13-17, wherein the speakers include at least a left-side speaker of the vehicle and a right-side speaker of the vehicle.

Aspect 19: The controller of any of Aspects 13-18, wherein the one or more processors, to obtain the information indicating the seating configuration, are configured to: obtain the information indicating the seating configuration from one or more sensors associated with the one or more seats of the vehicle.

Aspect 20: The controller of any of Aspects 13-19, wherein the one or more processors are further configured to: receive an indication of a designated seat of the vehicle, wherein the adjustment of the mapping of the audio channels to the speakers is responsive to the seat being the designated seat.

Aspect 21: The controller of any of Aspects 13-20, wherein the adjustment of the mapping of the audio channels to the speakers is only with respect to a subset of speakers associated with the seat.

Aspect 22: A controller, comprising: one or more memories; and one or more processors, coupled to the one or more memories, configured to: obtain information indicating a seating configuration for one or more seats of a vehicle; determine, in accordance with the seating configuration, that there is a disagreement between visual content on a display device associated with a seat, of the one or more seats, and multiple-channel audio associated with the visual content; and cause an adjustment of the visual content on the display device to cause agreement between the visual content and the multiple-channel audio.

Aspect 23: The controller of Aspect 22, wherein the seating configuration indicates at least one of directional orientations of the one or more seats or occupancy statuses of the one or more seats.

Aspect 24: The controller of any of Aspects 22-23, wherein the one or more processors, to cause the adjustment of the visual content, are configured to: cause flipping of the visual content except for textual content of the visual content.

Aspect 25: The controller of any of Aspects 22-24, wherein the one or more processors, to cause the adjustment of the visual content, are configured to: perform image segmentation on an image frame of the visual content to identify pixels of the image frame associated with textual content; perform a first operation to mirror-image flip the image frame, the first operation to result in mirror-image flipping of the textual content; perform a second operation to mirror-image flip the pixels associated with the textual content, the second operation to result in one or more empty pixels of the image frame; and perform a third operation to fill the empty pixels with a background color.

Aspect 26: The controller of any of Aspects 22-25, wherein the one or more processors, to obtain the information indicating the seating configuration, are configured to: obtain the information indicating the seating configuration from one or more sensors associated with the one or more seats of the vehicle.

Aspect 27: An apparatus, comprising: means for obtaining information indicating a seating configuration for one or more seats of a vehicle; means for determining, in accordance with the seating configuration, that there is a change to a directional orientation of a seat of the one or more seats; and means for causing, in accordance with the change to the directional orientation of the seat, an adjustment of a mapping of audio channels to speakers of the vehicle.

Aspect 28: The apparatus of Aspect 27, wherein the means for causing the adjustment of the mapping comprise: means for causing a left-side audio channel intended for a left-side speaker of the vehicle to be mapped to a right-side speaker of the vehicle and a right-side audio channel intended for the right-side speaker of the vehicle to be mapped to the left-side speaker of the vehicle.

Aspect 29: The apparatus of any of Aspects 27-28, further comprising: means for receiving an indication of a designated seat of the vehicle, wherein the adjustment of the mapping of the audio channels to the speakers is responsive to the seat being the designated seat.

Aspect 30: The apparatus of any of Aspects 27-29, wherein the adjustment of the mapping of the audio channels to the speakers is only with respect to a subset of speakers associated with the seat.

Aspect 31: A system configured to perform one or more operations recited in one or more of Aspects 1-30.

Aspect 32: An apparatus comprising means for performing one or more operations recited in one or more of Aspects 1-30.

Aspect 33: A non-transitory computer-readable medium storing a set of instructions, the set of instructions comprising one or more instructions that, when executed by a device, cause the device to perform one or more operations recited in one or more of Aspects 1-30.

Aspect 34: A computer program product comprising instructions or code for executing one or more operations recited in one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
obtaining, by a device, information indicating a seating configuration for one or more seats of a vehicle;
determining, by the device and in accordance with the seating configuration, that there is a change to an orientation of a seat, of the one or more seats, from a front-facing orientation to a rear-facing orientation or from the rear-facing orientation to the front-facing orientation;
causing, by the device and in accordance with the change to the orientation of the seat, an adjustment of a mapping of audio channels to speakers of the vehicle;
determining, by the device and in accordance with the seating configuration, that the adjustment of the mapping is to cause disagreement between visual content on a display device associated with an additional seat, of the one or more seats, and multiple-channel audio, associated with the visual content, to be output by the speakers; and
causing, by the device, an adjustment of the visual content on the display device to cause agreement between the visual content and the multiple-channel audio.

2. The method of claim 1, wherein the seating configuration indicates at least one of directional orientations of the one or more seats or occupancy statuses of the one or more seats.

3. The method of claim 1, wherein causing the adjustment of the mapping comprises:
causing a left-side audio channel intended for a left-side speaker of the vehicle to be mapped to a right-side speaker of the vehicle and a right-side audio channel intended for the right-side speaker of the vehicle to be mapped to the left-side speaker of the vehicle.

4. The method of claim 1, wherein causing the adjustment of the mapping comprises:
causing adjusting of an order of a content of an audio buffer.

5. The method of claim 1, wherein causing the adjustment of the mapping comprises:
causing updating of an audio input-output matrix used by an audio hardware abstraction layer.

6. The method of claim 1, wherein causing the adjustment of the visual content comprises:
causing flipping of the visual content except for textual content of the visual content.

7. The method of claim 1, wherein causing the adjustment of the visual content comprises:
performing image segmentation on an image frame of the visual content to identify pixels of the image frame associated with textual content;
performing a first operation to mirror-image flip the image frame, the first operation to result in mirror-image flipping of the textual content;
performing a second operation to mirror-image flip the pixels associated with the textual content, the second operation to result in one or more empty pixels of the image frame; and
performing a third operation to fill the empty pixels with a background color.

8. The method of claim 1, wherein the vehicle has a capability of autonomous operation.

9. The method of claim 1, wherein the speakers include at least a left-side speaker of the vehicle and a right-side speaker of the vehicle.

10. The method of claim 1, wherein the information indicating the seating configuration is obtained from one or more sensors associated with the one or more seats of the vehicle.

11. The method of claim 1, further comprising:
receiving an indication of a designated seat of the vehicle,
wherein the adjustment of the mapping of the audio channels to the speakers is responsive to the seat being the designated seat.

12. The method of claim 1, wherein the adjustment of the mapping of the audio channels to the speakers is only with respect to a subset of speakers associated with the seat.

13. A controller, comprising:
one or more memories; and
one or more processors, coupled to the one or more memories, configured to:
obtain information indicating a seating configuration for one or more seats of a vehicle;
determine, in accordance with the seating configuration, that there is a change to a directional orientation of a seat of the one or more seats; and
cause, in accordance with the change to the directional orientation of the seat, an adjustment of a mapping of audio channels to speakers of the vehicle.

14. The controller of claim 13, wherein the seating configuration indicates at least one of directional orientations of the one or more seats or occupancy statuses of the one or more seats.

15. The controller of claim 13, wherein the one or more processors, to cause the adjustment of the mapping, are configured to:
cause a left-side audio channel intended for a left-side speaker of the vehicle to be mapped to a right-side speaker of the vehicle and a right-side audio channel intended for the right-side speaker of the vehicle to be mapped to the left-side speaker of the vehicle.

16. The controller of claim 13, wherein the one or more processors, to cause the adjustment of the mapping, are configured to:
cause adjusting of an order of a content of an audio buffer.

17. The controller of claim 13, wherein the one or more processors, to cause the adjustment of the mapping, are configured to:
cause updating of an audio input-output matrix used by an audio hardware abstraction layer.

18. The controller of claim 13, wherein the speakers include at least a left-side speaker of the vehicle and a right-side speaker of the vehicle.

19. The controller of claim 13, wherein the one or more processors, to obtain the information indicating the seating configuration, are configured to:
obtain the information indicating the seating configuration from one or more sensors associated with the one or more seats of the vehicle.

20. The controller of claim 13, wherein the one or more processors are further configured to:
receive an indication of a designated seat of the vehicle,
wherein the adjustment of the mapping of the audio channels to the speakers is responsive to the seat being the designated seat.

21. The controller of claim 13, wherein the adjustment of the mapping of the audio channels to the speakers is only with respect to a subset of speakers associated with the seat.

22. A controller, comprising:
one or more memories; and
one or more processors, coupled to the one or more memories, configured to:
obtain information indicating a seating configuration for one or more seats of a vehicle;
determine, in accordance with the seating configuration, that there is a disagreement between visual content on a display device associated with a seat, of the one or more seats, and multiple-channel audio associated with the visual content; and
cause an adjustment of the visual content on the display device to cause agreement between the visual content and the multiple-channel audio.

23. The controller of claim 22, wherein the seating configuration indicates at least one of directional orientations of the one or more seats or occupancy statuses of the one or more seats.

24. The controller of claim 22, wherein the one or more processors, to cause the adjustment of the visual content, are configured to:
cause flipping of the visual content except for textual content of the visual content.

25. The controller of claim 22, wherein the one or more processors, to cause the adjustment of the visual content, are configured to:
perform image segmentation on an image frame of the visual content to identify pixels of the image frame associated with textual content;
perform a first operation to mirror-image flip the image frame, the first operation to result in mirror-image flipping of the textual content;
perform a second operation to mirror-image flip the pixels associated with the textual content, the second operation to result in one or more empty pixels of the image frame; and
perform a third operation to fill the empty pixels with a background color.

26. The controller of claim 22, wherein the one or more processors, to obtain the information indicating the seating configuration, are configured to:
obtain the information indicating the seating configuration from one or more sensors associated with the one or more seats of the vehicle.

27. An apparatus, comprising:
means for obtaining information indicating a seating configuration for one or more seats of a vehicle;
means for determining, in accordance with the seating configuration, that there is a change to a directional orientation of a seat of the one or more seats; and
means for causing, in accordance with the change to the directional orientation of the seat, an adjustment of a mapping of audio channels to speakers of the vehicle.

28. The apparatus of claim 27, wherein the means for causing the adjustment of the mapping comprise:
means for causing a left-side audio channel intended for a left-side speaker of the vehicle to be mapped to a right-side speaker of the vehicle and a right-side audio channel intended for the right-side speaker of the vehicle to be mapped to the left-side speaker of the vehicle.

29. The apparatus of claim 27, further comprising:
means for receiving an indication of a designated seat of the vehicle,
wherein the adjustment of the mapping of the audio channels to the speakers is responsive to the seat being the designated seat.

30. The apparatus of claim 27, wherein the adjustment of the mapping of the audio channels to the speakers is only with respect to a subset of speakers associated with the seat.
